(19) United States
(12) Patent Application Publication
(10) Pub. No.: US 2022/0122360 A1
(43) Pub. Date: Apr. 21, 2022

(54) Identification of suspicious individuals during night in public areas using a video brightening network system

(71) Applicant: AMARJOT SINGH, Danbury, CT (US)

(72) Inventor: AMARJOT SINGH, Danbury, CT (US)

(21) Appl. No.: 17/505,684

(22) Filed: Oct. 20, 2021

Related U.S. Application Data
(60) Provisional application No. 63/094,489, filed on Oct. 21, 2020.

(51) Int. Cl. G06V 20/52; G06V 10/40; G06V 40/10; G06V 10/764; G06T 5/00; G06N 3/08

(52) U.S. Cl. CPC G06V 20/52; G06V 10/40; G06V 40/103; G06T 2207/20084; G06T 5/00; G06N 3/08; G06V 10/764

(57) ABSTRACT

A real-time identification of suspicious individuals during night in public areas using a video brightening network system and method is provided in the present invention. The video brightening network system is a Generative Adversarial Network (GAN) that converts a very dark (night like) input video/input image (recorded from a standard RGB camera) into a bright (day like) output video/output image allowing a law enforcement to better monitor the scenes. Further, the present inventions provides identification of suspicious individuals using a ScatterNet Hybrid Deep Learning (SHDL) Network for performing pose estimation of the detected individuals by identifying a fourteen key-points of a human body, where the ScatterNet Hybrid Deep Learning (SHDL) Network is trained with a preconfigured dataset of individuals engaged in one or more suspicious or violent activities and a three dimensional (3D) ResNet for comparing the estimated pose of the detected individuals in the dataset and classifying to determine whether the suspicious individuals exist in the estimated pose.

### CROSS REFERENCE TO RELATED APPLICATIONS

This application claims priority on U.S. Provisional Patent Application No. 63/094,489, entitled “Identification of suspicious individuals during night in public areas using a video brightening network system”, filed on Oct. 21, 2020, which is incorporated by reference herein in its entirety and for all purposes.

### FIELD OF THE INVENTION

The present invention relates to identification of suspicious individuals during night in public areas using a video brightening network system. More particularly, the invention relates to the video brightening network system comprising a Generative Adversarial Network (GAN) to convert a very dark (night like) input video (recorded from a standard RGB camera) into a bright (day like) output video for allowing a law enforcement/an enforcement agency/a security agency etc., to better monitor the scenes. This helps in capturing individuals involved in suspicious activities/criminal activities such as riots, theft etc. perpetrating crimes during night or in a dark environment. Further helps in detecting harmful objects, weapons or other similar things carried by the individuals or engaged in such activities.

### BACKGROUND

In recent years, the rate of criminal activities and abnormal events by individuals and terrorist groups has been on the rise. The economic and social life is suffering so the safety and security of the public has become a major priority. The law enforcement agencies, enforcement agencies, security agencies etc., have been motivated to use video safety and security systems to monitor and curb these threats. Many automated video safety and security systems have been developed to monitor theft, fire or smoke, in home, office, commercial space, public areas etc.

There are some safety and security systems available to monitor and curb these threats, for examples U.S. patent application Ser. No. 15/894,214 discloses a method for detection of objects in the images. The method includes extracting a plurality of image frames received from one or more imaging devices, selecting at least one image frame from the plurality of image frames and then the selected image frame is analysed to determine the presence of one or more objects. The objects are then analyzed using the intensity of pixels in the selected image frame to determine if any of the objects is an anomaly. After that, a notification is created upon determining the anomaly present in the selected image frame, where the notification can indicate that the object is suspicious.

U.S. patent application Ser. No. 15/492,010 discloses a video security system and method for monitoring active environments that can detect and track objects that produce a security-relevant breach of a virtual perimeter. This system detects suspicious activities such as loitering and parking, and provides fast and accurate alerts.

But there are many problems, such as image enhancement, in image processing, computer graphics and computer vision that can be posed in transforming an input image into an output image. Currently, some have already taken significant steps in this direction, with convolutional neural nets (CNNs) becoming the common tool in a wide variety of image prediction problems. The convolutional neural nets (CNNs) learn to minimize a loss function and although the learning process is automatic, a lot of manual effort still goes into designing effective losses. In other words, we still have to tell the convolutional neural nets (CNNs) what we wish to minimize and if we take a naive approach and ask the convolutional neural nets (CNNs) to minimize the Euclidean distance between predicted and ground truth pixels, it will tend to produce blurry results. This is because Euclidean distance is minimized by averaging all plausible outputs, which causes blurring. Further with loss functions that force the convolutional neural nets (CNNs) to do what we really want e.g., output sharp, bright, realistic images is an open problem and generally requires expert knowledge.

Chinese patent application CN109636754A discloses a low illumination image enhancement method based on a generative adversarial network. The method includes obtaining original image data of an image, and pre-processing the original image data into a Generative Adversarial Network (GAN); wherein the Generative Adversarial Network (GAN) comprises a generation model for generated image is enhanced to an optimal image and a discrimination model, thus generating enhanced image as output.

Chinese patent application CN109658350A discloses a night face video image enhancement and noise reduction method. According to the method, detailed information such as edges and textures can be sharpened while the contrast ratio of the image is enhanced and the image is improved.

Chinese patent application CN109191388A discloses a dark image processing method and system. The method includes acquiring an image data set trained by a network, building a full convolutional network structure, training the full convolutional network to generate an enhanced image. This improves image processing effect and photographing experience by acquiring image data sets, training a full convolution network constructed, and processing dark images by using a generated full convolution network model to produce enhanced images.

Chinese patent application CN107038689A discloses a video brightening method. The video brightening method includes; channel screening for input images is carried out, and the images are divided into three single-channel images; anti-phase operation for the three single-channel images is carried out; dark channel images of the three single-channel images are calculated; statistics of histograms of the three single-channel images is carried out; statistics of environment light is carried out; gauss filtering is carried out; a transmissivity mapping table is calculated; brightening processing on the three single-channel images is carried out; and, data merging of the three single-channel images is carried out, and image output is carried out.

Chinese patent application CN106651817A discloses non-sampling contourlet fusion-based night image enhancement method. According to the method, an image reconstruction and fusion method is used to convert the RGB color into uniform color, and extract the luminance component as a grayscale, and then decompose to obtain the brightness and reflectance.

U.S. Pat. No. 10,055,827B2 disclose digital image filters and related methods for image contrast enhancement. The method includes determining an invariant brightness level for each pixel of an input image, the invariant brightness level is subtracted from the input brightness of the pixel. The resulting value is multiplied with a contrast adjustment constant and after that, the invariant brightness level is added.

U.S. Pat. No. 9,743,009B2 disclose an image processing method that includes obtaining an image by the image capturing unit, generating an average brightness of a dark part of the image by the image processing unit, recognizing the image by the image recognition unit; generating an average brightness of a human face by the image processing unit and generating a exposure value according to the average brightness of the dark part of the image, the average brightness of the human face and a weight array, when the human face is recognized from the image, and adjusting an exposure of the image according to the exposure value by the exposure adjusting unit.

There are many other patents and patent applications that disclose using deep learning (forms of convolutional neural networks or generative networks (GANS)) to either brighten the Red Green Blue (RGB) or infrared video or a combination of both for examples, U.S. Pat. No. 9,691,001B2, CN108320274A, CN105469115B etc.

But it is an extremely challenging task as the images or videos recorded by the camera such as surveillance cameras, Red Green Blue (RGB) cameras in public areas can suffer from illumination changes, shadows, poor resolution, and blurring. Also, the individuals can appear at different locations, orientations, and scales. Despite the above-explained techniques, the prior art systems and methods detects activities with less accuracy as images or videos captured in dark areas/night may fail to recognise the face of the individuals properly.

The prior art is not yet able to accurately identify the abnormal behaviour of individuals and identification of individuals involved in carrying objects of interest or weapons engaging in suspicious activities/criminal activities such as riots, theft etc., in the crowd or in large gathering at public areas. We should mention here that this limitation is for videos recorded in very dark lighting.

Hence, there is a need for an improved real-time system and method to identify suspicious individuals by recognizing their pose in dark/night videos. Therefore, the present invention provides a system and method for converting videos using a brightening network system that may help in identifying suspicious individuals in public areas. The technology can effectively prevent violent attacks, stampedes, and other emergencies; and provide timely warnings for real-time monitoring of anomalies so that timely appropriate action can be taken to curb these activities.

### SUMMARY

In order to solve the above problems, the present invention provides a video brightening network system for identification of suspicious individuals during night in public areas or in a controlled environment such as in the parking lots, public parks, roads etc.

According to aspects of the present invention, darker images or videos captured in an extremely low illumination environment or a night environment or dark environment (night like) is enhanced into clear and bright (day like) for identification of suspicious individuals.

In one aspect of the present invention is a system for identification of suspicious individuals in such environments, comprising; a plurality of cameras for monitoring a coverage area to detect incidents occurring in the said environment, where the camera constantly captures/records, and/or can be activated to capture/record images and/or videos based on a specific schedule and/or event; a brightening network using a Generative Adversarial Network (GAN) is configured for brightening enhancement on the said image/video and converting said image/video from dark (night like) to bright (day like) output image/video; a computing device for analysis and extracting features from the said output image/video; a YOLO (you only look once) detector for detecting one or more individuals based on the extracted features; a ScatterNet Hybrid Deep Learning (SHDL) Network for performing pose estimation of the detected individuals by identifying a fourteen key-points of a human body, where the ScatterNet Hybrid Deep Learning (SHDL) Network is trained with a preconfigured dataset of individuals engaged in one or more suspicious or violent activities; and a three dimensional (3D) ResNet for comparing the estimated pose of the detected individuals in the dataset and classifying to determine whether the suspicious individuals exist in the estimated pose.

In another aspect of the present invention, the system further includes the Regression Network (RN) that is trained on the suspicious posture datasets. In addition, new poses which are deemed as suspicious by the user would also be added in the memory and the Regression Network (RN) would be trained to detect these new poses in addition to old suspicious postures datasets making it a continuously evolving system. ‘The system has the ability to continuously learn new suspicious individuals, based on new postures, in addition to the postures presents in the suspicious training database. These new postures are identified as suspicious based on the user feedback. The memory attached to the Regression Network (RN) allows the user to train the Regression Network (RN) with new additions to the suspicious training dataset.

In one aspect of the present invention, the dataset comprising of thousands of individuals engaged in one or more suspicious or violent activities such as but not limited to Punching, Stabbing, Shooting, Kicking, Strangling Pushing, Shoving, Grabbing, Slapping, Physically assaulting, Hitting etc.

In one aspect of the present invention, the Generative Adversarial Network (GAN) converts a very dark (night like) image/video (recorded from a standard RGB camera or a surveillance camera) into a bright (day like) image/video that helps law enforcement to better monitor the scenes. The output image/video can help in capturing individuals involved in carrying objects of interest or weapons engaging in suspicious activities/criminal activities such as riots, theft etc.

In another aspect of the present invention, the 3D ResNet classifies the individuals as either neutral or assigns a most likely suspicious or violent activity label using the estimated poses.

In one aspect of the present invention, the brightening network comprising of the Generative Adversarial Network (GAN) includes conditional Generative Adversarial Networks (cGANs), the conditional Generative Adversarial Networks (cGANs) learn a conditional generative model for converting night video-to-day like video by analysing a condition on each scene of the said input image/video and generating a corresponding said output image/video.

As known, the structured losses for image modelling Image-to-image translation problems are often formulated as per pixel classification or regression. Therefore, in the present invention the Generative Adversarial Network (GAN) algorithm treats the output as “unstructured” in the sense that each output pixel is considered conditionally independent from all others given the input image. Further the conditional GANs instead learn a structured loss and the structured losses penalize the joint configuration of the output image/video.

In one aspect of the present invention provides enhancement of an image or a video from dark to bright where the algorithm doesn't apply a uniform transformation on each pixel but the transform is different for each pixel and is learned.

In one aspect of the present invention, the Generative Adversarial Network (GAN learn a loss adapted to the task and data at hand, which makes them applicable in a wide variety of settings.

In another aspect of the present invention is the method of identification of suspicious individuals during night in public areas. The method includes receiving at least one input image or an input video by a camera configured to monitor a coverage area to detect incidents occurring in the environment; performing brightening enhancement on said input image or on said input video by a brightening network using a Generative Adversarial Network (GAN) and converting said input image or said input video from dark (night) to bright (day like) output image or output video having non-uniform transformation on each pixel, where the enhancement is from dark to bright with non-uniform transformation on each pixel; performing brightening enhancement on said input image or on said input video by a brightening network using a Generative Adversarial Network (GAN) and converting said input image or said input video from dark (night) to bright (day like) output image or output video having non-uniform transformation on each pixel into an output image or output video; performing analysis for extracting features from the output image or the output video; detecting one or more individuals from the extracted features in the output image or the output video; performing pose estimation of the detected individuals by identifying a fourteen key-points of a human body by a ScatterNet Hybrid Deep Learning (SHDL) Network, where the ScatterNet Hybrid Deep Learning (SHDL) Network is trained with a dataset of violent individuals engaged in one or more suspicious or violent activities; and comparing the estimated pose of the detected individuals in the dataset and classifying for determining whether the suspicious individuals exist in the estimated pose.

In one more aspect of the present invention provides monitoring such as but not limited to criminal activities, abnormal events or incidents by the individuals.

In another aspect of the present invention, the 14 key-points are annotated on the human body as Facial Region (P1—Head, P2—Neck); Arms Region (P3—Right shoulder, P4—Right Elbow, P5—Right Wrist, P6—Left Shoulder, P7—Left Elbow, P8—Left Wrist) and Legs Region (P9—Right Hip, P10—Right Knee, P11—Right Ankle, P12—Left Hip, P13—Left Knee, P14—Left Ankle).

One advantage of the present invention is identifying suspicious individuals or violent individuals in public areas or in a controlled environment in low-lighting conditions.

One advantage of the present invention is detecting individuals engaged in violent/suspicious activities in public areas or large gatherings in real time.

One advantage of the present invention is identification of suspicious individuals or violent individuals is on-site processing or processing on a cloud server in real-time.

One advantage of the present invention is brightening enhancement is on-site processing or processing on a cloud server for performing computations in real-time for identifying the suspicious individuals.

### BRIEF DESCRIPTION OF THE DRAWINGS

The object of the invention may be understood in more details and more particularly description of the invention briefly summarized above by reference to certain embodiments thereof which are illustrated in the appended drawings, which drawings form a part of this specification. It is to be noted, however, that the appended drawings illustrate preferred embodiments of the invention and are therefore not to be considered limiting of its scope, for the invention may admit to other equally effective equivalent embodiments.

FIG. 1 illustrates an exemplary a system for converting night videos/night images to day videos/day images using brightening network system in accordance with the present invention;

FIG. 2 illustrates an exemplary system for identification of suspicious individuals in public areas in accordance with the present invention;

FIG. 3 illustrates an example of video/image before and after conversion in accordance with the present invention;

FIG. 4 illustrates 14 key-points annotated on a human body in accordance with the present invention; and

FIG. 5 is a flowchart illustrating a method of identifying violent individuals in accordance with the present invention.

### DETAILED DESCRIPTION OF THE INVENTION

The present invention will now be described more fully hereinafter with reference to the accompanying drawings in which a preferred embodiment of the invention is shown. This invention may, however, be embodied in many different forms and should not be construed as being limited to the embodiment set forth herein. Rather, the embodiment is provided so that this disclosure will be thorough, and will fully convey the scope of the invention to those skilled in the art.

For understanding of the person skilled in the art, the term “suspicious or violent individuals/persons” as used herein refers to the human being engaged in one or more of the violent activities such as but not limited to Punching, Stabbing, Shooting, Kicking, Strangling Pushing, Shoving, Grabbing, Slapping, Physically assaulting, Hitting etc.

As described herein with several embodiments, under-exposure and darker images or videos captured in an extremely low illumination environment or a night environment or dark environment (night like) can be enhanced into clear and bright (day like) by a system and a method provided by the present invention.

Further in the embodiments, the present invention provides identification of suspicious individuals during night in public areas using a brightening network system to convert dark images or dark videos into clear and bright (day like) images or videos.

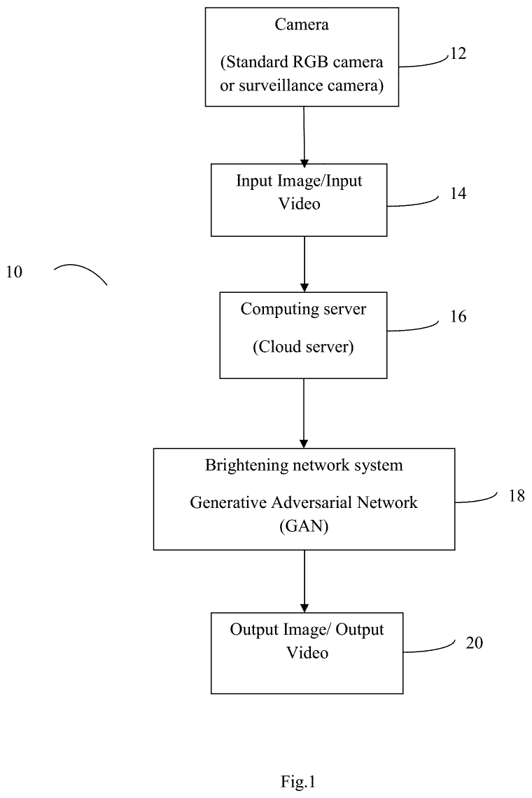

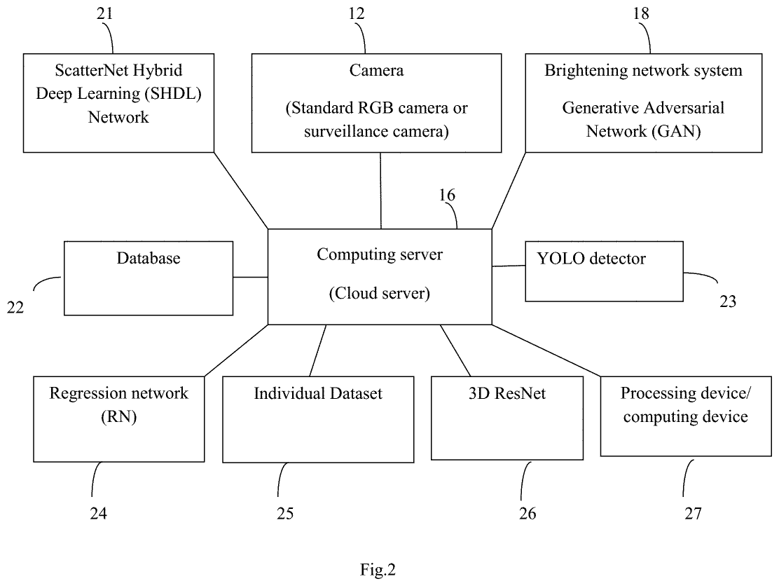

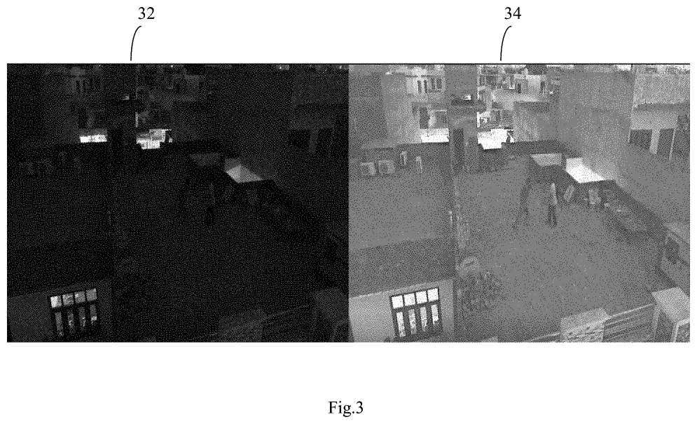

Now, the invention will be described herewith referring to the Figures. As shown in FIG. 1 and FIG. 2, in one embodiment the invention provides a system 10 comprising one or more cameras 12 configured to monitor a coverage area to detect incidents occurring within and/or approximate to the coverage area and respond to these incidents accordingly. The camera 12 is a standard Red Green Blue (RGB) camera or surveillance camera configured for capturing/recording images or videos hereinafter referred as input image/input video 14. A computing server (cloud server) 16 that includes a Brightening network system (configured with a Generative Adversarial Network (GAN)) 18 for converting a very dark (night like) input image/input video 14 into a bright (day like) output image/output video 20 (as shown in FIG. 3) that allows a law enforcement to better monitor the scenes.

The Generative Adversarial Network (GAN) 18 is configured with an algorithm to convert very dark (night like) input image/input video 14 into a bright (day like) output image/output video 20. This output image/output video 20 helps in identifying individuals involved in carrying harmful objects or weapons engaging in suspicious activities/criminal activities such as riots, theft etc.

In some embodiments, the Generative Adversarial Network (GAN) 18 includes a conditional Generative Adversarial Network (cGAN) with conditional setting just as the Generative Adversarial Network (GAN) 18 learns a generative model of data, the conditional Generative Adversarial Network (cGAN) learn a conditional generative model. This makes the conditional Generative Adversarial Network (cGAN) suitable for converting night video-to-day like video, where it analyses the condition on scene on an input image/input video 14 and generates a corresponding output image/output video 20.

The Generative Adversarial Network (GAN) 18 treats the output as “unstructured” in the sense that each output pixel is considered conditionally independent from all others given the input image/input video 14. Further, the conditional Generative Adversarial Network (cGAN) instead learn a structured loss and the structured losses penalize the joint configuration of the output image/output video 20. Therefore, it can be said that the present invention provides enhancement of an image or a video from dark to bright where the algorithm doesn't apply a uniform transformation on each pixel but the transform is different for each pixel and is learned.

In some embodiments, the Generative Adversarial Network (GAN) 18 has two parts, a generator and discriminator. The generator learns to generate plausible data. The generated plausible data become negative training examples for the discriminator. The discriminator learns to distinguish the generator's fake data from real data. The discriminator penalizes the generator for producing implausible results. Both the generator and the discriminator are neural networks. The generator output is connected directly to the discriminator input and through back propagation, the discriminator's classification provides a signal that the generator uses to update its weights.

Now as shown in FIG. 2, the system 10 will be described herein with more details. In the embodiments of the present invention after converting dark input image/input video 14 into the bright output image/output video 20, analysis on the output image/output video is performed for extracting features. A computing server (cloud server) 16 performs computing functions in real-time, whereas the computing server (cloud server) 16 is configured with the YOLO (you only look once) detector 23 to detect one or more individuals from the output image/output video 20 based on the extracted features, wherein detection of the individuals is on-site processing or processing on the computing server (cloud server 16) in real-time. After that a ScatterNet Hybrid Deep Learning (SHDL) Network 21 comes in the picture for pose estimation of the detected individuals, where the ScatterNet Hybrid Deep Learning (SHDL) Network 21 identifies fourteen key-points of a human body to form a skeleton structure of the detected individuals, and a three dimensional (3D) ResNet 26 for classification to determine whether anomalies/suspicious individuals exist in the estimated pose. The ScatterNet Hybrid Deep Learning (SHDL) Network 21 is trained with preconfigured Individuals Dataset 25 to perform analysis of the identified key-points, where the Individual Dataset 25 is composed of thousands of images and thousands of individuals engaged in one or more suspicious or violent activities.

As said above, the system 100 is preconfigured with an Individual Dataset 25. The Individual Dataset 25 includes images with individuals recorded at different variations of scale, position, illumination, blurriness, etc. This Individual Dataset 25 is used by the ScatterNet Hybrid Deep Learning (SHDL) network 21 to learn pose estimation. The Individual Dataset 25 is composed of thousands of images, where each image contains at least two individuals. The complete datasets consist of thousands of individuals engaged in one or more of the suspicious or violent activities such as but not limited to Punching, Stabbing, Shooting, Kicking, Strangling Pushing, Shoving, Grabbing, Slapping, Physically assaulting, Hitting etc. Further, each individual the output image 20 is annotated with at least 14 key-points which are utilized by the proposed ScatterNet Hybrid Deep Learning (SHDL) network 21 as labels for learning pose estimation. The system 10 further includes the Regression Network (RN) 24 that is trained on the suspicious postures datasets. In addition, new poses which are deemed as suspicious would also be added in a memory (not shown) associated with the Regression Network (RN) 24 and the Regression Network (RN) 24 is trained to detect these new poses in addition to old suspicious postures datasets making it a continuously evolving system. Further, the Regression Network (RN) 24 uses structural priors to expedite the training as well as reduce the dependency on the annotated datasets. And in one important aspect, the system 10 includes a three dimensional (3D) ResNet 26 that classifies the individuals as either neutral or assigns the most likely suspicious or violent activity label trained using the vector of orientations computed using the estimated poses of the human body.

The system has the ability to continuously learn new suspicious individuals, based on new postures, in addition to the postures presents in the suspicious training database. These new postures are identified as suspicious based on the user feedback. The memory attached to the Regression Network (RN) 24 allows the user to train the Regression Network (RN) 24 with new additions to the suspicious training dataset.

Further in the embodiments, each individual in the output image/output video 20 is annotated with several key-points, in this example 14 key-points which are utilized by the proposed network as labels for learning pose estimation. In an exemplary embodiment, 14 key-points (described later in document) are utilized by the proposed invention without limiting the scope of the present invention.

As discussed herein, the system 10 makes use of the YOLO detector 23 to detect individuals quickly from the output image/output video 20 recorded by the camera 12.

The YOLO detector 23 uses a single neural network that is applied on the complete output image/output video. This network divides the output image 20 into regions and predicts bounding boxes and probabilities for each region. These bounding boxes are weighted by predicted probabilities to detect individuals.

In some implementations, the limbs of the skeleton are given as input to a three dimensional (3D) ResNet 26 which classifies the individuals as either neutral or assigns the most likely violent activity label.

The computing system/processing system 27 can identify the persons of interest in real-time. In some implementations, the computing server (cloud server) 16 is configured to access database(s) 22 to obtain any requisite information that may be required for its analysis.

Though various other neural networks, deep learning systems, etc., can be used for the identification of violent activities and violent individuals, the neural network used for this work is the ScatterNet Hybrid Deep Learning (SHDL) Network 21 is composed of a hand-crafted ScatterNet front-end and a back-end formed of a supervised learning-based multi-layer deep network. The ScatterNet Hybrid Deep Learning (SHDL) Network 21 is constructed by replacing the first convolutional, relu and pooling layers of the multi-layer deep network with the hand-crafted parametric log ScatterNet. This accelerates the learning of the multi-layer deep network as the Scatter-Net front-end extracts invariant (translation, rotation, and scale) edge features, which can be directly used to learn more complex patterns from the start of learning. The invariant edge features can be beneficial for identification as the humans can appear with these variations in the images/videos.

FIG. 3 shows an example of a dark scene 32 of an input image/input video 14 and bright scene 44 as output image/output video 20 after converting using the Generative Adversarial Network (GAN) 18 as proposed by the present invention.

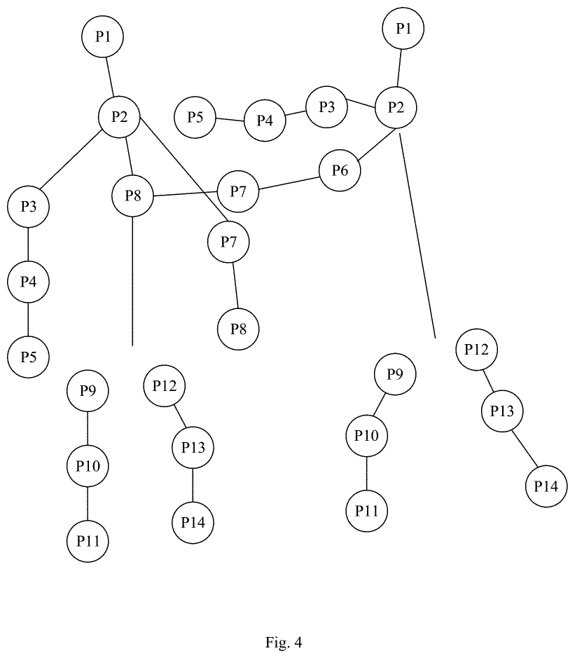

FIG. 4 shows the proposed 14 key-points annotated on the human body. In some embodiments the Facial Region includes P1—Head and P2—Neck; the Arms Region includes P3—Right shoulder, P4—Right Elbow, P5—Right Wrist, P6—Left Shoulder, P7—Left Elbow and P8—Left Wrist; and the Legs Region includes P9—Right Hip, P10—Right Knee, P11—Right Ankle, P12—Left Hip, P13—Left Knee, and P14—Left Ankle.

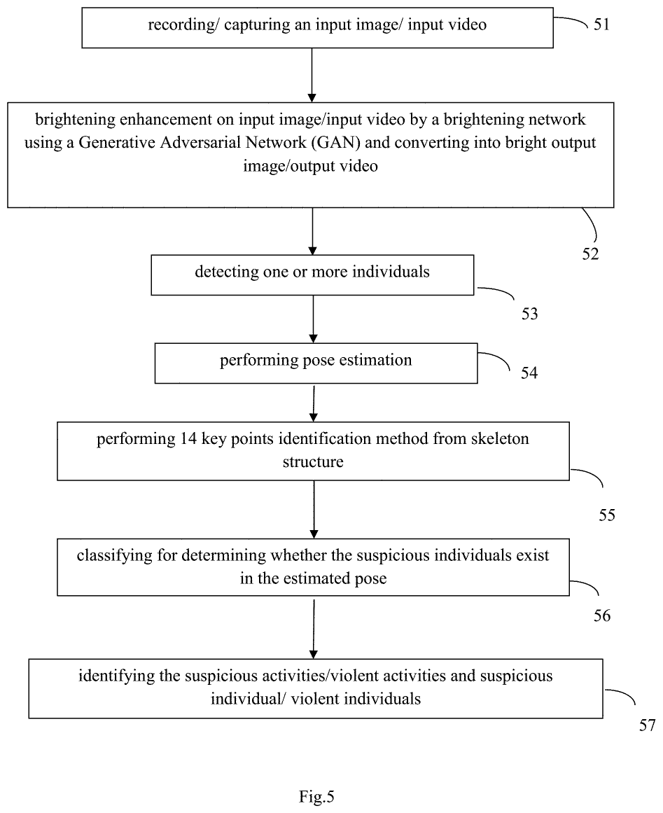

Further, as shown in FIG. 5, in another embodiment, the present invention provides an exemplary method for identifying suspicious or violent individuals/humans in public areas and monitoring criminal activities and abnormal events or incidents by the individuals using the system 10. According to some implementations of the present invention, the method is described herein with various steps without departing from the scope of the invention. Step 51, is capturing/recording one or more image(s), video(s), (e.g., a human, a location, etc.) by the camera 12 configured to monitor a coverage area to detect incidents occurring in the environment. The camera 12 can perform constant capturing/recording, and/or can be activated to capture/record based on a specific schedule then the input image(s)/input video(s) are transferred to the computing server (cloud server) 16. Step 52, is performing brightening enhancement on input image(s)/input video(s) 14 by a brightening network using a Generative Adversarial Network (GAN) 18 and converting into bright (day like) output image(s)/output video(s) 20. Step 53, is performing analysis on the bright output image(s)/output video(s) 20 for the purposes of extracting features and based on extracted features detecting one or more individuals using the YOLO detector 23. Step 54, the detected individuals in the output image/output video 20 can be further analyzed for pose estimation of the individuals using the ScatterNet Hybrid Deep Learning (SHDL) Network 21 to determine whether anomalies exist in the captured/recorded images. Step 55, is performing 14 key points identification method from skeleton structure and analysis of the identified key points. Step 56 is the classification method for determining whether the suspicious individuals exist in the estimated pose and then finally at step 57, is identifying the suspicious activities/violent activities and suspicious individual/violent individuals.

The implementations of the described technology, in which the system is connected with a network server and a computer system capable of executing a computer program to execute the functions. Further, data and program files may be input to the system, which reads the files and executes the programs therein. Some of the elements of a general purpose computer system are a processor having an input/output (I/O) section, a Central Processing Unit (CPU), and a memory.

The described technology is optionally implemented in software devices loaded in memory, stored in a database, and/or communicated via a wired or wireless network link, thereby transforming the computer system into a special purpose machine for implementing the described operations.

The embodiments of the invention described herein are implemented as logical steps in one or more computer systems. The implementation is a matter of choice, dependent on the performance requirements of the computer system implementing the invention. Accordingly, the logical operations making up the embodiments of the invention described herein are referred to variously as operations, steps, objects, or modules. Furthermore, it should be understood that logical operations may be performed in any order, unless explicitly claimed otherwise or a specific order is inherently necessitated by the claim language.

The foregoing description of embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated.

What is claimed is:

1. A system for identification of suspicious individuals in dark environment, the system comprising:
at least one input image or an input video by at least one camera monitoring a coverage area to detect incidents occurring in the said environment;
brightening enhancement on said input image or on said input video by a brightening network using a Generative Adversarial Network (GAN) and converting said input image or said input video from dark (night) to bright (day like) output image or output video having non-uniform transformation on each pixel;
at least one computing server for analysis and extracting features from the said output image or the output video;
detecting one or more individuals form the extracted features by a YOLO detector;
performing pose estimation of the detected individuals by identifying a fourteen key-points of a human body by a ScatterNet Hybrid Deep Learning (SHDL) Network, where the ScatterNet Hybrid Deep Learning (SHDL) Network is trained with a dataset of violent individuals engaged in one or more suspicious or violent activities; and
comparing the estimated pose of the detected individuals in the dataset and classifying by a three dimensional (3D) ResNet for determining whether the suspicious individuals exist in the estimated pose.

2. The system of claim 1, further includes monitoring the coverage area to detect incidents occurring within and/or approximate to the coverage area and responding to these incidents.

3. The system of claim 1, further includes monitoring such as but limited to criminal activities, abnormal events or incidents by the individuals.

4. The system of claim 1, wherein the identification of suspicious individuals is on-site processing or processing on a cloud server in real-time.

5. The system of claim 1, wherein the brightening enhancement is on-site processing or processing on a cloud server for performing computations in real-time for identifying the suspicious individuals.

6. The system of claim 1, wherein the brightening network comprises the Generative Adversarial Network (GAN) includes conditional Generative Adversarial Networks (cGANs).

7. The system of claim 1, wherein the conditional Generative Adversarial Networks (GANs) learn a conditional generative model for converting dark night like the input image or input video into bright day like the output image or output video by analysing a condition on each scene of the said input image or input video and generating a corresponding said like the output image or output video.

8. The system of claim 1, wherein the Generative Adversarial Network (GAN) comprises a generator and a discriminator, where the generator learns to generate plausible data and the discriminator learns to distinguish the generator's fake data from real data.

9. The system of claim 1, wherein comparing the estimated pose in the dataset, the dataset comprising thousands of individuals engaged in one or more suspicious or violent activities such as but not limited to Punching, Stabbing, Shooting, Kicking, Strangling Pushing, Shoving, Grabbing, Slapping, Physically assaulting, Hitting.

10. The system of claim 1, wherein the fourteen key-points are annotated on the human body as Facial Region (P1—Head region, P2—Neck), Arms Region (P3—Right shoulder, P4—Right Elbow, P5—Right Wrist, P6—Left Shoulder, P7—Left Elbow, P8—Left Wrist) and Legs Region (P9—Right Hip, P10—Right Knee, P11—Right Ankle, P12—Left Hip, P13—Left Knee, P14—Left Ankle).

11. The system of claim 1, wherein the 3D ResNet classifies the individuals as either neutral or assigns a most likely suspicious or violent activity label using the estimated poses.

12. A method of identification of suspicious individuals in dark environment, the method comprising:
receiving at least one input image or an input video by a camera configured to monitor a coverage area to detect incidents occurring in the environment;
performing brightening enhancement on said input image or on said input video by a brightening network using a Generative Adversarial Network (GAN) and converting said input image or said input video from dark (night) to bright (day like) output image or output video;
performing analysis for extracting features from the output image or the output video;
detecting one or more individuals from the extracted features in the output image or the output video;
performing pose estimation of the detected individuals by identifying a fourteen key-points of a human body by a ScatterNet Hybrid Deep Learning (SHDL) Network, where the ScatterNet Hybrid Deep Learning (SHDL) Network is trained with a dataset of violent individuals engaged in one or more suspicious or violent activities; and
comparing the estimated pose of the detected individuals in the dataset and classifying for determining whether the suspicious individuals exist in the estimated pose.

13. The method of claim 12, further includes monitoring the coverage area to detect incidents occurring within and/or approximate to the coverage area and responding to these incidents.

14. The method of claim 12, further includes monitoring such as but limited to criminal activities, abnormal events or incidents by the individuals.

15. The method of claim 12, wherein the brightening enhancement is on-site processing or processing on a cloud server for performing computations in real-time for identifying the suspicious individuals.

16. The method of claim 12, wherein the identification of suspicious individuals is on-site processing or processing on a cloud server in real-time.

17. The method of claim 12, wherein detecting one or more individuals form the extracted features by a YOLO detector.

18. The method of claim 12, wherein comparing the estimated pose of the detected individuals in the dataset and classifying by a three dimensional (3D) ResNet for determining whether the suspicious individuals exist in the estimated pose.

19. The method of claim 12, wherein comparing the estimated pose in the dataset, the dataset comprising thousands of individuals engaged in one or more suspicious or violent activities such as but not limited to Punching, Stabbing, Shooting, Kicking, Strangling Pushing, Shoving, Grabbing, Slapping, Physically assaulting, Hitting.

20. The method of claim 12, wherein the fourteen key-points are annotated on the human body as Facial Region (P1—Head region, P2—Neck), Arms Region (P3—Right shoulder, P4—Right Elbow, P5—Right Wrist, P6—Left Shoulder, P7—Left Elbow, P8—Left Wrist) and Legs Region (P9—Right Hip, P10—Right Knee, P11—Right Ankle, P12—Left Hip, P13—Left Knee, P14—Left Ankle).
